(19) United States
(12) Patent Application Publication
(10) Pub. No.: US 2014/0379297 A1
(43) Pub. Date: Dec. 25, 2014

(54) ACCOMPANIMENT DETERMINATION APPARATUS, ACCOMPANIMENT DETERMINATION METHOD, AND COMPUTER READABLE STORAGE MEDIUM

(71) Applicants: YAHOO JAPAN CORPORATION, Tokyo (JP); THE UNIVERSITY OF TOKYO, Tokyo (JP)

(72) Inventors: Kota TSUBOUCHI, Tokyo (JP); Masamichi SHIMOSAKA, Tokyo (JP); Ryoma KAWAJIRI, Tokyo (JP)

(21) Appl. No.: 14/305,392

(22) Filed: Jun. 16, 2014

(30) Foreign Application Priority Data
Jun. 20, 2013 (JP) 2013-129496

(51) Int. Cl. G01C 22/00

(52) U.S. Cl. CPC G01C 22/006
USPC 702/160

(57) ABSTRACT

An accompaniment determination apparatus includes a sensor information receiver configured to receive from sensors worn by two or more users sensor information that associates observation information acquired by the sensors with time point information indicating a time point at which the observation information is acquired, a similarity information calculation unit configured to calculate similarity information related to similarity in a set of observation information, corresponding to the time point information at a determination time point to determine whether the two or more users are accompanying, an accompaniment determination unit configured to determine that the two or more users wearing the sensors having acquired the observation information used to calculate the similarity information are accompanying each other if the similarity information is similar enough to satisfy a predetermined condition, and an output unit configured to output information indicating a determination result determined by the accompaniment determination unit.

### CROSS-REFERENCE TO RELATED APPLICATIONS

The present invention contains subject matter related to Japanese Patent Application No. 2013-129496 filed in the Japan Patent Office on Jun. 20, 2013, the entire contents of which are incorporated herein by reference.

### BACKGROUND OF THE INVENTION

1. Field of the Invention

The present invention relates to an accompaniment determination apparatus, an accompaniment determination method, and a computer readable storage medium for determining whether users axe accompanying each other.

2. Description of the Related Art

There is a need to extract a relationship of two users from information acquired from sensors worn by the two users. For example, Japanese Unexamined Patent Application Publication No. 2011-40063 discloses an apparatus that acquires information related to surroundings of a user using position information acquired by a sensor worn by the user.

Such a related art technique based on position information is used to determine whether two or more users are accompanying each other. The related art technique of collecting a track of the user involves high costs to protect privacy of the user.

### SUMMARY OF THE INVENTION

A simple mechanism is desirable to determine with sufficient privacy ensured whether two or more users are accompanying each other.

According to a first aspect of the present invention, an accompaniment determination apparatus includes a sensor information receiver configured to receive from sensors worn by two or more users sensor information that associates observation information acquired by the sensors with time point information indicating a time point at which the observation information is acquired, a similarity information calculation unit configured, to calculate similarity information related to similarity in a set of observation information, corresponding to the time point information at a determination time point to determine whether the two or more users are accompanying, the set of observation information included in the sensor information received by the sensor information receiver, an accompaniment determination unit configured to determine that the two or more users wearing the sensors having acquired the observation information used to calculate the similarity information are accompanying each other if the similarity information is similar enough to satisfy a predetermined condition, and an output unit configured to output information indicating a determination result determined by the accompaniment determination unit.

According to a second aspect of the present invention, the similarity information calculation unit may calculate the similarity information at the determination time point using a plurality of sets of observation information respectively corresponding to the time point information respectively indicating time points included in a sampling time including the determination time point.

According to a third aspect of the present invention, the similarity information calculation unit may calculate the similarity information resulting from summing differences, each difference between at least two pieces of observation information included in the plurality of sets of observation information respectively corresponding to the time point information respectively indicating time points included in the sampling time including the determination time point.

According to a fourth aspect of the present invention, the accompaniment determination apparatus may further include a relation intensity information calculation unit configured to calculate relation intensity information, on each of the sets of the sensor information received by the sensor information receiver. The relation intensity information is a value of an intensity of relationship between the two users wearing the sensors and indicates a higher relationship as a possibility that the users are accompanying each other is higher. The output unit outputs information related to the relation intensity information.

According to a fifth aspect of the present invention, the accompaniment determination apparatus may further include a clustering unit configured to cluster users having a higher relationship into same class using the relation intensity information. The output unit outputs a clustering result of the clustering unit.

### BRIEF DESCRIPTION OF THE DRAWINGS

FIG. 1 is a block diagram illustrating an accompaniment determination apparatus of an embodiment;

FIG. 2 illustrates an example of two pieces of sensor information of the embodiment;

FIG. 3 is a flowchart illustrating an example of an operation of the accompaniment determination apparatus of the embodiment;

FIG. 4 is a flowchart illustrating an example of the operation of the accompaniment determination apparatus of the embodiment;

FIG. 5 is a flowchart illustrating an example of the operation of the accompaniment determination apparatus of the embodiment;

FIG. 6 illustrates an example of clustering results displayed by an output unit of the embodiment;

FIG. 7 is an external view of a computer system of the embodiment; and

FIG. 8 illustrates an example of a configuration of the computer system of the embodiment.

### DETAILED DESCRIPTION OF THE PREFERRED EMBODIMENTS

Embodiments of an accompaniment determination apparatus are described with reference to the drawings. In the following discussion, like elements operate in the same manner, and the discussion of any element, once described, is omitted as appropriate.

An accompaniment determination apparatus 1 of the present embodiment determines whether two or more users respectively wearing sensors having acquired sensor information are accompanying each other.

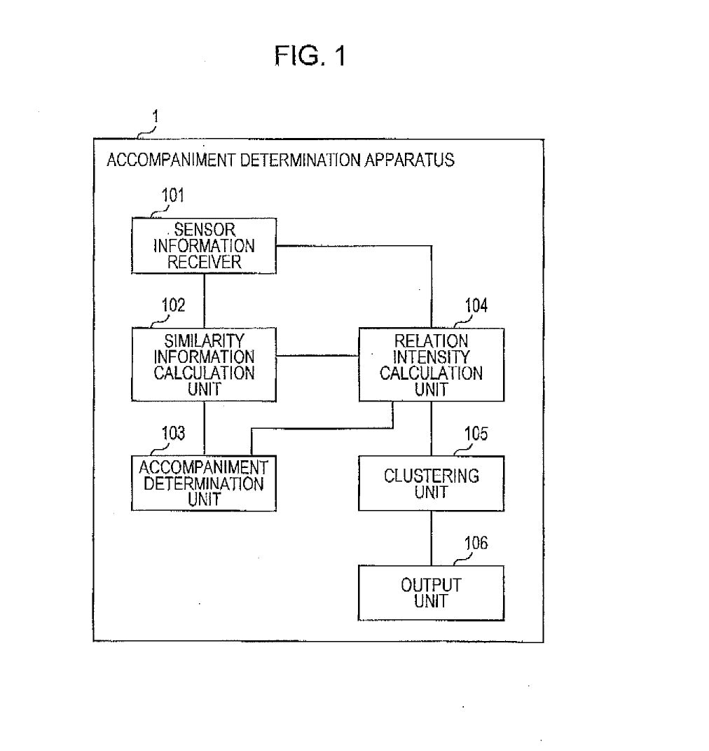

FIG. 1 is a block diagram illustrating the accompaniment determination apparatus 1 of the embodiment. The accompaniment determination apparatus 1 includes the sensor information receiver 101, a similarity information calculation unit 102, an accompaniment determination unit 103, a relation intensity calculation unit 104, a clustering unit 105, and an output unit 106.

The sensor information receiver 101 receives sensor information from two or more sensors. The sensor information receiver 101 thus receives the sensor information from sensors worn by two or more users. The sensor information is information that associates at least one set of observation information acquired by the sensor and time point information indicating a time point at which the observation information is acquired.

The sensor may be an acceleration sensor that detects acceleration, a gyro sensor that detects an angular velocity, an illuminance sensor that detects illuminance, a geomagnetic sensor that detects the direction of a magnetic field, a temperature sensor that detects a temperature, a humidity sensor that detects humidity, or a pressure sensor that detects atmospheric pressure. Furthermore, the sensor may be an accelerometer, a pedometer, or a calorie consumption meter. In other words, the observation information acquired by the sensor may be information indicating detected acceleration, or information calculated from the detected acceleration. The information calculated from the acceleration may be the number of steps taken by a user using the accelerometer, or an amount of calorie consumed by the user and acquired by the accelerometer. The following discussion is based on the premise that the sensor is a pedometer. The pedometer may be of a type of counting the number of steps by detecting acceleration through an acceleration sensor, or of a type of counting the number of steps by detecting acceleration through the swing of a pendulum. Since these pedometers count the number of steps based on acceleration, it is understood that the number of steps is acquired using the accelerometer.

Time point information associated with the observation information may be information indicating an instantaneous time point or information indicating a duration of time having a time width. The information of the instantaneous time point indicates one point in the time axis. If the time point information indicates a duration of time having a time width, the time point information may indicate one hour, one minute, or one second, or a duration of time having another time width. The time point information may indicate a duration of from 10 hours 00 minutes 00 seconds to 10 hours 59 minutes 59 second, 99 . . . . The “association between the observation information and the time point information” may be in a one-to-one correspondence, or in a multi-to-one correspondence. For example, the sensor information may associate the time point information “from 12:00, Jun. 1, 2013 to 12:01, Jun. 1, 2013” with a single piece of observation information “100 steps”, or 100 pieces of observation information “one step”. Upon receiving the latter case information, namely, the multi-to-one information, the sensor information receiver 101 may convert the latter case information to the former case information, namely, the one-to-one information. The following discussion is based on the premise that the former case information has been received. The sensor information may or may not include a plurality of pieces of time point information indicating the same time point. The word group “includes the plurality of pieces of time point information indicating the same time point” is intended to mean that the time point information and the observation information “one step” are acquired in association with each other at each step. If the sensor information including the plurality of pieces of time point information indicating the same time point is received, the sensor information receiver 101 may merge the time point information and the observation information corresponding thereto so that the time point information indicating the same time point is not duplicated. The verb “merge” is intended to mean that the plurality of pieces of time point information indicating the same time point are unified and that the observation information associated with the plurality of pieces of time point information is re-associated with the unified time point information. The following discussion is based, on the premise that the sensor information does not include a plurality of pieces of time point information indicating the same time point.

The sensor information may or may not include user identification information identifying a user wearing a sensor from which the sensor information is acquired. If the sensor information receiver 101 receives three or more pieces of sensor information, each piece of sensor information desirably includes user identification information. For example, the user identification information is preferably the name of the user. Alternatively, the user identification information may be identification (ID) indicating the user, or a telephone number. For example, if it is determined that users related to sensor information a and sensor information b are accompanying each other, an easier-to-understand output provided by the output unit 106 is an output that “‘the name of the user related to the sensor information a’ and ‘the name of the user related to the sensor information b’ are accompanying each other” rather than an output that “the sensor information a is accompanying the sensor information b”. The sensor information receiver 101 may receive the sensor information transmitted via wired or wireless communication line. The sensor information receiver 101 may receive information read from a recording medium, such as an optical disc, a magnetic disc, or a semiconductor memory.

The similarity information calculation unit 102 calculates similarity information. The similarity information is related to similarity in a set of observation information, corresponding to the time point information at a determination time point to determine accompaniment, the set of observation information included in two or more pieces of sensor received by the sensor information receiver 101. The similarity information may be higher in value as similarity increases, or may be lower in value as similarity increases. The similarity information may be any value. Preferably, the similarity information may be a value that is normalized to be within a specific range. The similarity information may be similarity information related to two pieces of sensor information or similarity information related to three or more pieces of sensor information. More specifically, the observation information set may include two pieces of observation information or three or more pieces of observation information. The similarity information calculation unit 102 calculates the similarity information of the two pieces of observation information at a single process. If the observation information set includes three or more pieces of observation information, the similarity information calculation unit 102 may calculate the similarity information of all combinations of the sensor information including the observation information, and calculate the mean value or the sum as the similarity information. The similarity information calculation unit 102 may group the sensor information into two groups, and calculate the similarity information using representative data of each group. When the sensor information is grouped, the similarity information calculation unit 102 may group the sensor information using information that associates a group stored on a memory not illustrated) with the sensor information. Alternatively, the similarity information calculation unit 102 may group the sensor information so that the sensor information having similar observation information therewithin is in the Same group. If the sensor information receiver 101 receives two or more pieces of sensor information, the similarity information calculation unit 102 may calculate the similarity information of the two or more pieces of sensor information. If the sensor information receiver 101 receives three or more pieces of sensor information, the similarity information calculation unit 102 may calculate the similarity information on all sets of combination of two or more pieces of sensor information, or may calculate the similarity information on some sets of combination of the two or more pieces of sensor information. The time point indicated by the determination time point may be a time point input by the user and received by a reception unit (not illustrated), a time point set by another processing unit, or a time point corresponding to any time point information included in the sensor information. The determination time point expressed by “the time point corresponding to any time information included in the sensor information” may be one or more pieces of time point information randomly selected from the time point information included in the sensor information. A period from the time point indicated by the oldest time point information in the sensor information to the time point indicated by the youngest time point information in the sensor information may be divided into N durations, and the determination time point may be any time point in each of the N durations. The period from the time point indicated by the oldest time point information in the sensor information to the time point indicated by the youngest time point information in the sensor information may be divided by a predetermined duration, and the determination time point may be any time point in each of the durations. N is a natural number equal to or above 1. The predetermined duration may be one minute, ten minutes, or the like. The predetermined duration may be empirically or statically determined. The determination time point may be information indicating an instantaneous time point or a duration having a time width. If the determination time point indicates a duration having a time width, the determination time point may indicate one minute, one second, or any other duration having a different time width. The number of time points may be one or more.

The time point information corresponding to the determination time point may indicate the same time point as the determination time point, or a time point close to the determination time point. The relationship of the determination time point of “the time point information corresponding to the determination time point” with the time point information may be in a one-to-one correspondence or a one-to-multi correspondence. In the latter case, the time point information corresponding to the determination time point may be time point information of a time point included in a sampling period including the determination time point. For this reason, the similarity information calculation unit 102 may calculate the similarity information at the determination time point using a plurality of observation information sets corresponding to the time point information indicating the time points included in the sampling period. The similarity information calculation unit 102 may calculate the similarity information by summing values of differences between two or more pieces of observation information included in the observation information sets corresponding to pieces of time point information indicating time points included in the sampling period.

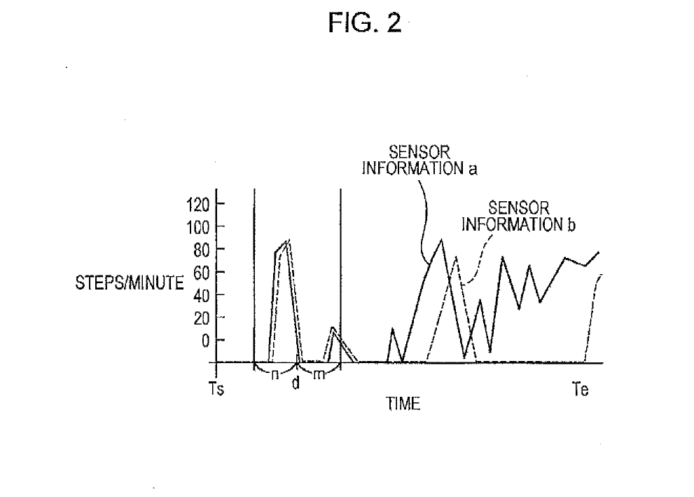

The sampling period may include a duration lasting to the determination time point and/or a duration lasting from the determination time point. An example of the sampling period is described with reference to FIG. 2. FIG. 2 illustrates sensor information a and sensor information b respectively acquired from sensor a and sensor b. The sensors in FIG. 2 record the number steps taken by a user per minute. As illustrated in FIG. 2, d represents the determination time point, n represents a duration including a time point lasting to the determination time point, and in represents a duration including a time point lasting from the determination time point. The sampling period in FIG. 2 lasts from the time point d-n to the time point d+m. Note that n and m are positive real numbers. One of n and m may be zero, or both n and m may be non-zero numbers. If there are two or more determination time points, two or more sampling periods are present. If there are two or more sampling periods, one sampling period may or may not overlap another sampling period. The sampling period may be one minute period delineated by a respective determination time point. For example, the sampling period may be 60 minutes, namely, 30 minutes lasting to the determination time point and 30 minutes lasting from the determination time point. As another example, the sampling period may be 60 seconds, namely, 30 seconds lasting to the determination time point and 30 seconds lasting from the determination time point.

The similarity information calculation unit 102 calculates the similarity information using the observation information set as described above. The observation information set is a combination of two or more pieces of observation information respectively included in two or more pieces of sensor information. More specifically, the observation information set is a set that is difficult to obtain from a single piece of sensor information. The observation information set may correspond to the time point information indicating the same time point or may correspond to two or more pieces of different time information closely apart. In the two or more pieces of sensor information, intervals of acquisition of the observation information may be different or the time points of acquisition of the observation information may be different. In that case, as well, “the observation information set corresponding to the two or more pieces of different time information closely apart” may be the observation information set that is acquired at an acquisition interval of the observation information shorter than a predetermined threshold value.

The similarity information calculation unit 102 may calculate the similarity information using the degree of similarity of a waveform of the observation information or in accordance with a predetermined formula. If the similarity information is calculated in accordance with the predetermined formula, the predetermined formula may be a formula based on a ratio of the observation information sets, a formula based on a difference between the observation information sets, or a formula obtained by modifying one of these formulas. The formula based on the ratio includes an expression (observation information a/observation information b), for example. The formula based on a difference includes an expression (observation information a−observation information b), for example. The formula based on a difference may include a formula including the value of a difference. The value of the difference may be the absolute value of a difference in the observation information, or a value resulting from squaring the difference in the observation information. The formula obtained by modifying one of these formulas may be a formula resulting from multiplying the observation information in the formula by a predetermined coefficient, a formula resulting from subtracting a predetermined value from the observation information in the formula, or a formula resulting from multiplying the observation information in the formula by a predetermined value. The method of calculating the similarity information using the degree of similarity of waveform is a related art technique, and the detailed discussion thereof is omitted herein. If the predetermined formula is used to calculate the similarity information of the two pieces of the sensor information, the value of difference may be used as expressed in Formula (1):

$${α}_{d} ( a , b ) = {\sum }_{t = d - n}^{d + m} ( {a}_{t}^{2} + {b}_{t}^{2} ) \\ {Δ}_{d} ( a , b ) = \frac{{\sum }_{t = d - n}^{d + m} {( {a}_{t} - {b}_{t} )}^{2}}{{α}_{d} ( a , b )} \qquad ( 1 )$$

In Formula (1), d represents the determination time point, α_{d}(a,b) represents a value to normalize the similarity information at the determination point, Δ_{d}(a,b) represents within a range of 0.0 through 1.0 a value into which the similarity information at the determination time point d is normalized, n represents a duration from the start point of the sampling period to the determination time point d, m represents a duration from the determination time point d to the end point of the sampling period. Also, aₜ and bₜ respectively represent the observation information at time point t included in the two pieces of sensor information, and (aₜ−bₜ) represents the value of the difference in the observation information set corresponding to the time point t in Formula (1). Formula (1) is the similarity information that indicates that the closer to zero the value of Δ_{d} is, the more similar the two pieces of sensor information are to each other. The similarity information calculation unit 102 may set the similarity info/Elation to be 1.0 or no value if the denominator of Δ_{d} in Formula (1) becomes zero. If the value of α_{d} is smaller than a predetermined threshold value, the similarity information calculation unit 102 may set the similarity information to be 1.0 or no value. If there is only a slight variation in the similarity information, a user may possibly fall asleep, and it may be considered that there is no need to use αₐ in the calculation of the similarity information. In the following discussion, θα represents the threshold value with respect to α_{d}. The calculation formula to calculate the similarity information of the two pieces of sensor information may be Formula (2) described below or another formula.

$${Δ}_{d} ( a , b ) = \frac{{\sum }_{t = d - n}^{d + m} ( {a}_{t}^{2} - {b}_{t}^{2} )}{{α}_{d} ( a , b )} \qquad ( 2 )$$

In Formula (2), (aₜ²−bₜ²) represents a value related to the value of difference of the observation information set at time point t.

If the similarity information is similar enough to satisfy a predetermined condition, the accompaniment determination unit 103 determines that two or more users wearing sensors from which the observation information used to calculate the similarity information has been acquired are accompanying each other at the determination time point. The predetermined condition in the determination that the higher the value of the similarity information is, the more similar the observation information is may be that the value of the similarity information is equal to or above a predetermined threshold value. The predetermined condition in the determination that the lower the value of the similarity information is, the more similar the observation information is, the predetermined condition may be that the value of the similarity information is equal to or below a predetermined threshold value. The predetermined threshold value may be determined manually or through a statistic process from the past sensor information by referencing the sensor information acquired by the sensors worn by the two or more users actually accompanying each other. Alternatively, the predetermined threshold value may be determined by development engineers, an administrator, or other persons. The accompaniment determination unit 103 may determine whether the users corresponding to the two pieces of integral sensor information are accompanying each other, using Formula (3).

S_{d}(a,b)=AND(α_{d}(a,b)>θ_{α},Δ_{d}(a,b)<θ_{Δ}) (3)

In Formula (3), S_{d}(a,b) is a function that is equal to 1 if the users corresponding to the sensor information a and b are accompanying each other at the determination time point, and is equal to zero if the users are not accompanying each other at the determination time point. θ_{α} represents a threshold value with respect to a value α_{d}(a,b) that normalizes the similarity information. θ_{Δ} represents a threshold value with respect to the similarity information to determine whether the users are accompanying each other. AND(argument 1, argument 2) is a function that becomes equal to 1 only when the argument 1 is equal to the argument 2, and otherwise becomes zero.

The relation intensity calculation unit 104 calculates relation intensity information of users corresponding to each set of two pieces of sensor information received by the sensor information receiver 101. The relation intensity information is a value indicating the intensity of relationship between the two users wearing the sensors. As the relation intensity information indicates a higher intensity of the relationship, the accompaniment determination unit 103 determines with a higher possibility that the users are accompanying each other. More specifically, as the period throughout which the users are accompanying each other is determined to be longer, the relation intensity information indicates a higher intensity of the relationship. The relation intensity calculation unit 104 may calculate the relation intensity information of all or some combinations of pieces of sensor information received by the sensor information receiver 101. The relation intensity calculation unit 104 may calculate the relation intensity information on part or whole of adoration including all time points indicated by the time point information included in the sensor information received by the sensor information receiver 101.

The relation intensity information is preferably a numerical value, but may be information other than a numerical value. For example, the relation intensity information may be stepwise level information, such as “strong”, “weak”, and “none”. The relation intensity information may be the number of times by which the accompaniment determination unit 103 determines that the users corresponding to the two sensors are accompanying each other, or may be a value calculated from the determined number of times of accompaniment. The relation intensity calculation unit 104 may calculate the relation intensity information in accordance with Formula (4):

$$W = {\sum }_{t = Ts}^{Te} {δ}_{t} \\ {δ}_{t} = {\prod }_{τ = t}^{t + c} {S}_{τ} ( a , b ) \qquad ( 4 )$$

In Formula (4), W represents the relation intensity information, Ts represents a first time point of a target duration over which the relation intensity information is calculated, Te represents a last time point of the target duration over which the relation intensity information is calculated, and c represents a duration holding that δt equals 1 within a duration throughout which the users are determined to be accompanying each other.

The clustering unit 105 clusters users having a higher relation intensity into the same class using the relation intensity information. The users having a higher relation intensity have a larger number of times by which they are determined as accompanying each other. If the relation intensity information calculated based on two pieces of sensor information is not information indicating “zero” or no value, the clustering unit 105 may cluster the users into the same class. If the relation intensity information is equal to or above a threshold value, the clustering unit 105 may cluster the users into the same class. A variety of related art techniques are available as the clustering technique based on a relation intensity between two elements, and the detailed discussion thereof is thus omitted herein.

The output unit 106 outputs information indicating determination results of the accompanying user determiner 103. The information indicating the determination results may be information about the determination performed on the two pieces of sensor information received by the sensor information receiver 101 as to whether the users are accompanying each other at the determination time point, or may be information related to the relation intensity information. The information related to the relation intensity information may be the relation intensity information itself, or may be information indicating clustering results of the two or more pieces of sensor information received by the sensor information receiver 101. The output unit 106 may output the information to a display. When the relation intensity information or the information indicating the clustering results is output, the output unit 106 may visualize numerical data of the information. The visualization of the numerical data includes displaying the relation intensity of the users in an icon or by the thickness of a line connecting the users. The clustering users may be enclosed in a circle. The output unit 106 may display the information on a display, project the information using a projector, print the information on a printer, output a sound responsive to the information, transmit the information, to an external apparatus, store the information onto a recording medium, and/or transfer the information to another processing apparatus or another program.

The similarity information calculation unit 102, the accompaniment determination unit 103, the relation intensity calculation unit 104, the clustering unit 105, and the output unit 106 may be typically implemented by an microprocessing unit (MPU), a memory, and the like. A process of the clustering unit 105 is typically implemented using software, and the software is stored on a storage medium, such as a read-only memory (ROM). The process of the clustering unit 105 may also be implemented using hardware.

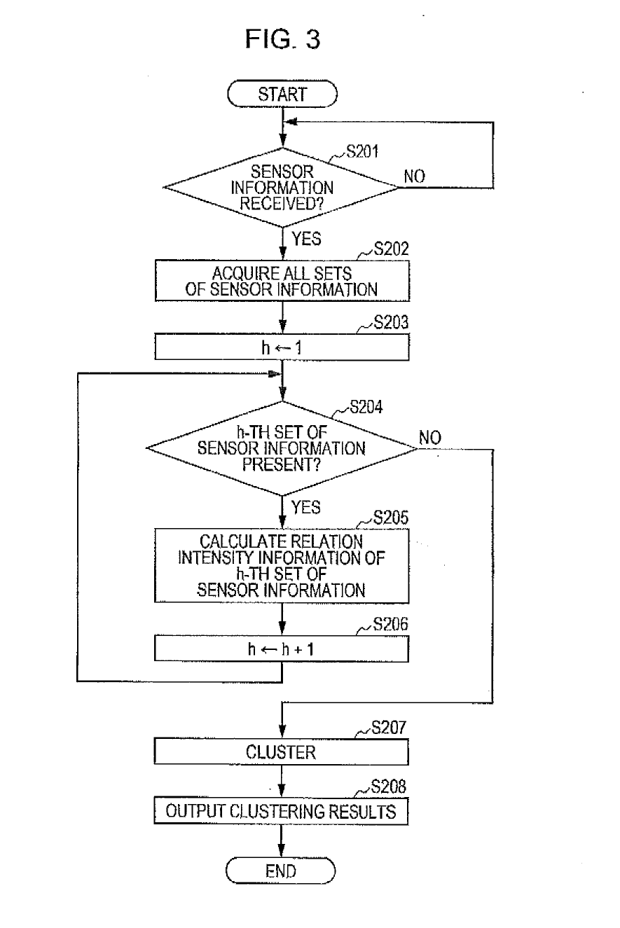

An operation of the accompaniment determination apparatus 1 is described with reference to a flowchart of FIG. 3. In the flowchart, the sensor information receiver 101 receives two pieces of sensor information.

Step S201 The sensor information receiver 101 receives two or more pieces of sensor information. If the sensor information is received, processing proceeds to step S202. If no sensor information is received, step S201 is repeated. The sensor information receiver 101 temporarily stores the received sensor information on a memory (not illustrated).
Step S202 The relation intensity calculation unit 104 acquires all sets of combination, each set including two pieces of sensor information received in step S201.

Step S203 The relation intensity calculation unit 104 substitutes 1 for a count at a counter h.

Step S204 The relation intensity calculation unit 104 checks whether an h-th set of sensor information is present. If the h-th set of sensor information is present, processing proceeds to step S205. If no h-th set of sensor information is present, processing proceeds to step S207.
Step S205 The relation intensity calculation unit 104 calculates the relation intensity information on the h-th set of sensor information.
Step S206 The relation intensity calculation unit 104 increments the count at the counter h by 1. Processing proceeds to step S204.
Step S207 The clustering unit 105 performs a clustering operation using the relation intensity information calculated in step S205.
Step S208 The output unit 106 outputs information indicative of the clustering result obtained in step S207.

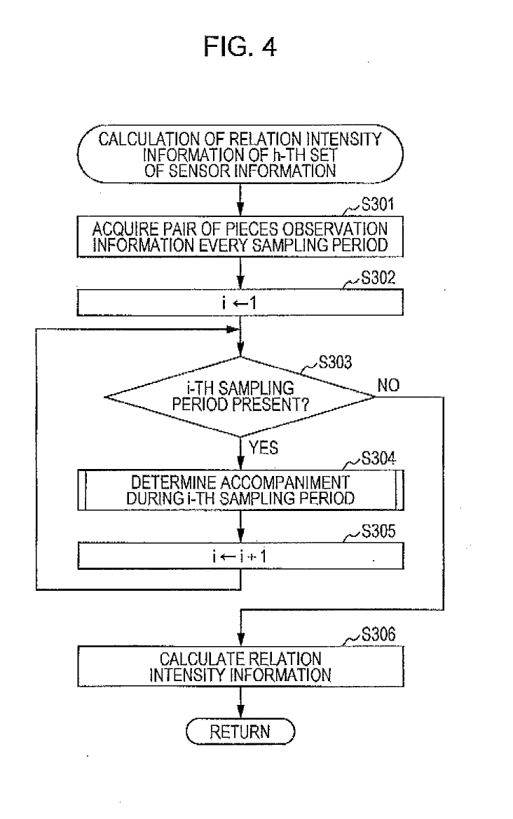

The operation in step S205 by the relation intensity calculation unit 104 is described in detail with reference to a flowchart of FIG. 4. Note that the operations in step S301 through S306 are performed on the h-th set of sensor information acquired in the flowchart of FIG. 3.

Step S301 The relation intensity calculation unit 104 acquires an observation information set included in the sensor information every sampling period. The sampling period is applicable to each period corresponding to a determination time point.
Step S302 The relation intensity calculation unit 104 substitutes 1 for the count at a counter h.

Step S303 The relation intensity calculation unit 104 determines whether an i-th sampling period is present or not. If an i-th sampling period is present, processing proceeds to step S304. If no i-th sampling period is present, processing proceeds to step S306.

Step 304 The accompaniment determination unit 103 calculates the sensor information during the i-th sampling period to determine whether the users are accompanying each other.
Step S305 The relation intensity calculation unit 104 increments the count at the counter i by 1. Processing returns to step S303.
Step S306 The relation intensity calculation unit 104 calculates the relation intensity information. Processing returns to an upper process.

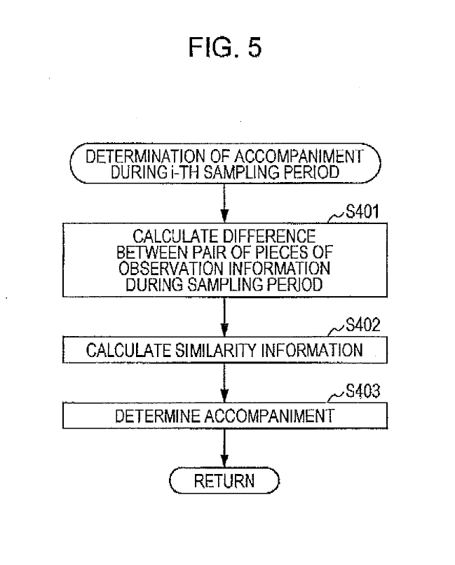

The operation in step S304 by the similarity information calculation unit 102 is described in detail with reference to a flowchart of FIG. 5. Note that operations in steps S401 through S403 are a process of the i-th sampling period included in the h-th set of sensor information acquired in the flowcharts of FIG. 3 and FIG. 4.

Step S401 The similarity information calculation unit 102 calculates a difference in the observation information set corresponding to the time point information included in the sampling period.
Step S402 The similarity information calculation unit 102 calculates the similarity information using the value of the difference acquired in step S401.

Step S403 The accompaniment determination unit 103 determines whether the similarity information calculated in step S402 is equal to or below a predetermined threshold value. If the similarity information is equal to or below the predetermined threshold, the accompaniment determination unit 103 determines that the users are accompanying each other. Processing returns to the upper process.

A specific operation of the accompaniment determination apparatus 1 of the embodiment is described below. Note that the sensor information includes the observation information of about one month in the specific operation. The sampling period includes 30 minutes lasting to the determination time point and 30 minutes lasting from the determination time point. If the similarity information is lower than the predetermined threshold value, the accompaniment determination unit 103 determines that the users are accompanying each other.

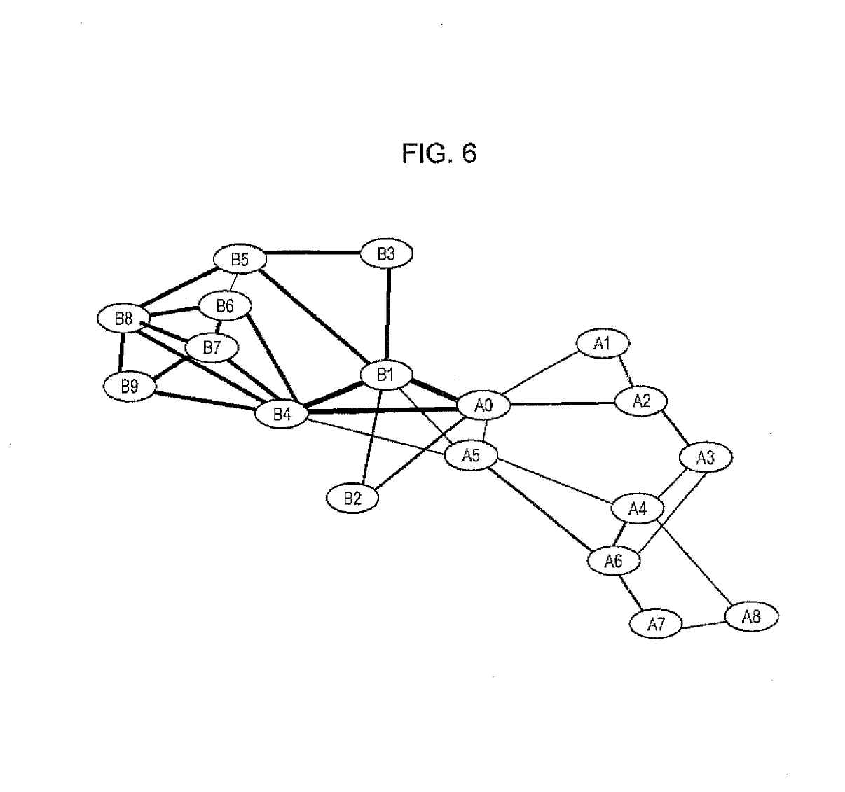

The administrator of the accompaniment determination apparatus 1 interprets the loading of an optical disk storing the sensor information acquired by pedometers respectively worn by 18 users to the accompaniment determination apparatus 1 as the inputting of the sensor information. The sensor information receiver 101 receives the input sensor information of 18 sensors (step S201). When the sensor information receiver 101 receives the sensor information, the relation intensity calculation unit 104 acquires 153 ways or sets of combination by which two pieces of sensor information are selected from a group of 18 pieces of sensor information received from the sensor information receiver 101 (step S202). The relation intensity calculation unit 104 selects one set of combination from the 153 sets of combination (steps 6203 and 5204). The accompaniment determination unit 103 acquires an observation information set every sampling period with respect to the set of sensor information selected by the relation intensity calculation unit 104 (steps S205 and S301). The relation intensity calculation unit 104 selects a single sampling period from all the sampling periods (steps S302 and S303). The similarity information calculation unit 102 calculates a value of difference in the observation information set corresponding to the sampling period included in the set of sensor information selected by the relation intensity calculation unit 104 (steps S304 and S401). The similarity information calculation unit 102 calculates the similarity information during the sampling period from the calculated value of difference (step S402). When the similarity information is calculated, the accompaniment determination unit 103 determines whether the users are accompanying each other (step S403). The similarity information calculation unit 102 and the accompaniment determination unit 103 calculate the similarity information in all the sampling periods to determine whether the users are accompanying (step S305). Upon completing the accompaniment during each sampling period, the relation intensity calculation unit 104 calculates the relation intensity information (step S306). The relation intensity calculation unit 104 calculates the relation intensity on all the 153 sets of combination of sensor information (step S206). When the relation intensity calculation unit 104 completes the calculation of the relation intensity on all the 153 sets of combination of sensor information, the clustering unit 105 clusters the users corresponding to the 18 types of sensor information (S207). When the clustering unit 105 completes the clustering operation, the output unit 106 outputs the clustering results (step S208). The output unit 106 outputs a relationship diagram of FIG. 6 on the display.

A test performed in connection with the embodiment are described below. In the test, the clustering operation was performed on the observation information indicating the number of steps counted by the pedometers respectively worn by the 18 users during a month. The precondition of the test is described below. The pedometer used was Fitbit (registered trademark). The collection period of the sensor information was from Jan. 17, 2013 to Feb. 17, 2013. The users wearing the pedometers ranged in age from 21 to 42 years old. The users wearing the predomenter ranged in weight from 61 to 71 kg. The users wearing the predomenters ranged in height from 167 to 182 cm. In this test, the determination time point was set every minute. In Formula (4), t is incremented every minute. The sampling period included 30 minutes lasting to the determination time point and 30 minutes lasting from the determination time point. In other words, the sampling period was 60 minutes. In the test, the calculation method of the similarity information was Formula (1). Since the sampling period included 30 minutes lasting to the determination time point and 30 minutes lasting from the determination time point, m and n in Formula (1) is 30. In the test, Formula (3) was used to determine whether the user are accompanying each other or not. In Formula (3), θα was 5500. θΔ was 0.05. Formula (4) was used as the calculation method of the relation intensity. Ts in Formula (4) was 00 hours 00 minute, Jan. 17, 2013, Te was 23 hours 59 minutes, Feb. 17, 2013. In Formula (4), c was 15 (minutes).

The output unit 106 outputs the relationship diagram of FIG. 6 as a rest result. Nodes starting with A in the relationship diagram represent research members in a certain corporate. A link between nodes is indicated by a thicker line as the relation intensity information has a higher value. Nodes starting with B represent research members of a certain university. A0, A1, and A2 were in the same research team. A3, A5, and A6 were in the same research team. A4 and A6 were in the same research team. A4 was a team leader. B1, B3, and B5 were on the same grade. B4, B6, B7, B8, and B9 were on the same grade. B2 was a team leader of B nodes. A0, B1, B2, and B4 were working on the same project. The clustering of FIG. 6 is considered to be likely to indicate the actual relationship among the users. The calculation of the relation intensity based on the determination results given by the accompaniment determination unit 103 is found effective to detect the relationship among the users. The use of the pedometer as a relatively simple sensor allows the relationship of the user to be extracted without collecting the position information.

With the similarity information calculation unit 102 calculating the similarity information, the accompaniment determination apparatus 1 of the embodiment determines whether the users wearing the sensors are accompanying each other. The similarity information calculation unit 102 calculates the similarity information during the sampling period, thereby providing the similarity information that is free from a small error in the acceleration detected by the sensor. With the sensor detecting the number of steps, the accompaniment determination apparatus 1 determines without collecting the position information whether the users are accompanying each other. The relation intensity calculation unit 104 calculates the relation intensity information based on the accompaniment determination result, thereby easily calculating the relationship among the users. The clustering unit 105 performs the clustering operation using the relation intensity information, thereby easily verifying the relationship among the users.

In the present embodiment described above, the accompaniment determination apparatus 1 includes the clustering unit 105. However, the accompaniment determination apparatus 1 may not necessarily have to include the clustering unit 105. If the accompaniment determination apparatus 1 includes no clustering unit 105, the output unit 106 simply outputs the information related to the determination result of the accompaniment determination unit 103 or the information related to the relation intensity information.

In the present embodiment described, the accompaniment determination apparatus 1 includes the relation intensity calculation unit 104. However, the accompaniment determination apparatus 1 may not necessarily have to include the relation intensity calculation unit 104. If the accompaniment determination apparatus 1 includes no relation intensity calculation unit 104, the output unit 106 may simply output the information related to the determination result of the accompaniment determination unit 103.

The software implementing the accompaniment determination apparatus 1 of the present embodiment may be a program described below. The program causes a computer to function as a sensor information receiver, a similarity information calculation unit, an accompaniment determination unit, and an output unit. The sensor information receiver receives from sensors worn by two or more users sensor information that associates observation information acquired by the sensors with time point information indicating a time point at which the observation information is acquired. The similarity information calculation unit calculates similarity information related to similarity in a set of observation information, corresponding to the time point information at a determination time point to determine whether the two or more users are accompanying, the set of observation information included in the sensor information received by the sensor information receiver. The accompaniment determination unit determines that the two or more users wearing the sensors having acquired the observation information used to calculate the similarity information are accompanying each other if the similarity information is similar enough to satisfy a predetermined condition. The output unit outputs information indicating a determination result determined by the accompaniment determination unit.

In the present embodiment, each process (function) may be centrally controlled by a single apparatus (system), or may be processed in a distributed fashion by a plurality of apparatuses. In the present embodiment, two or more communication units in one apparatus may be implemented by one physical unit.

In the present embodiment, each element may be implemented using dedicated hardware. An element that may be implemented using software may be implemented by executing the software program. For example, the software program recorded on a hard disk or a semiconductor memory may be read and then executed by a program executing unit, such as a central processing unit (CPU). Each element is thus implemented.

The functions implemented by the program are free from any function that may be implemented only by hardware. For example, in an acquisition unit to acquire information or an output unit to output information, modem or an interface card, which is implemented only by hardware, is not included in the functions implemented by the program.

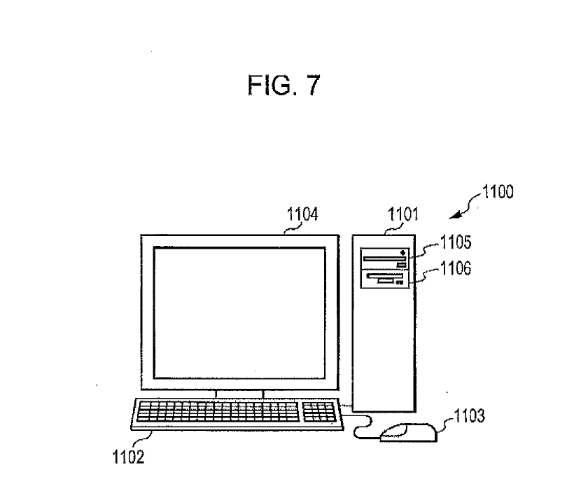

FIG. 7 diagrammatically illustrates a computer implementing the embodiment of the present invention. The present embodiment is implemented by the computer as hardware and the computer program that is executed on the computer.

As illustrated in FIG. 7, a computer system 1100 include a computer 1101 including a compact disk read-only memory (CD-ROM) drive 1105, and a flexible disk (FD) drive 1106, a keyboard 1102, a mouse 1103, and a display 1104.

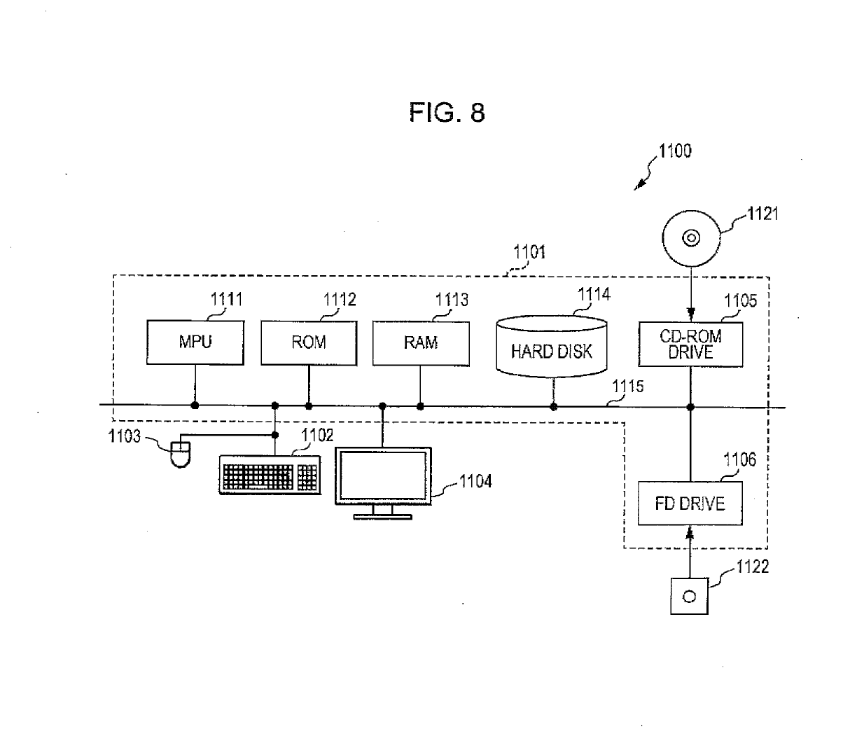

FIG. 8 illustrates an internal structure of the computer system 1100. As illustrated in FIG. 8, the computer 1141 includes a micro-processor unit (MPU) 1111, a ROM 1112, a random-access memory (RAM) 1113, a hard disk 1114, and a bus 1115, in addition to the CD-ROM drive 1105, and the FD drive 1106. The ROM 1112 stores programs including an bootup program. The RAM 1113, connected to the MPU 111, temporarily stores an instruction of an application program and provides a temporary storage space. The hard disk 1114 stores the application program, a system program, and data. The bus 1115 interconnects the MPU 1111, the ROM 1112, and other elements. The computer 1101 may include a network card (not illustrated) that permits connection to a local area network (LAN).

The program that causes the computer system 1100 to perform the functions of the present embodiment of the invention is stored on a CD-ROM 1121 or an FD 1122. The CD-ROM 1121 or the FD 1122 is then inserted into the CD-ROM drive 1105 or the FD drive 1105. The program may be transferred to the hard disk 1114. Alternatively, the program may be transmitted to the computer 1101 via a network not illustrated) and then stored on the hard disk 1114. The program is then loaded onto the RAM 1113 to be executed. Alternatively, the program may be directly loaded onto the RAM 1113 from the CD-ROM 1121 or the FD 1122, or via the network.

The program may not necessarily have to include an operating system (OS) that causes the computer 1101 to perform the functions of the present embodiment or a third-party program. The program may include only a command portion to invoke an appropriate function (module) in a controlled form and to obtain a desired result. The operation of the computer system 1100 is known and the detailed description thereof is omitted herein.

The present invention is not limited to the present embodiment. Various modifications are possible and falls within the scope of the present invention. In the present invention, the “unit” may be interpreted as a “section” or a “circuit”.

The accompaniment determination apparatus of the present embodiment determines that two users are accompanying each other, using sensor information without collecting position information.

What is claimed is:

1. An accompaniment determination apparatus, comprising:
a sensor information receiver configured to receive from sensors worn by two or more users sensor information that associates observation information acquired by the sensors with time point information indicating a time point at which the observation information is acquired;
a similarity information calculation unit configured to calculate similarity information related to similarity in a set of observation information, corresponding to the time point information at a determination time point to determine whether the two or more users are accompanying, the set of observation information included in the sensor information received by the sensor information receiver;
an accompaniment determination unit configured to determine that the two or more users wearing the sensors having acquired the observation information used to calculate the similarity information are accompanying each other if the similarity information is similar enough to satisfy a predetermined condition; and
an output unit configured to output information indicating a determination result determined by the accompaniment determination unit.

2. The accompaniment determination apparatus according to claim 1, wherein the similarity information calculation unit calculates the similarity information at the determination time point using a plurality of sets of observation information respectively corresponding to the time point information respectively indicating time points included in a sampling time including the determination time point.

3. The accompaniment determination apparatus according to claim 2, wherein the similarity information calculation unit calculates the similarity information resulting from summing differences, each difference between at least two pieces of observation information included in the plurality of sets of observation information respectively corresponding to the time point information respectively indicating time points included in the sampling time including the determination time point.

4. The accompaniment determination apparatus according to claim 1, further comprising a relation intensity information calculation unit configured to calculate relation intensity information, on each of the sets of the sensor information received by the sensor information receiver, the relation intensity information being a value of an intensity of relationship between the two users wearing the sensors and indicating a higher relationship as a possibility that the users are accompanying each other is higher; and
wherein the output unit outputs information related to the relation intensity information.

5. The accompaniment determination apparatus according to claim 4, further comprising a clustering unit configured to cluster users having a higher relationship into same class using the relation intensity information,
wherein the output unit outputs a clustering result of the clustering unit.

6. An accompaniment determination method, comprising:
receiving from sensors worn by two or more users sensor information that associates observation information acquired by the sensors with time point information indicating a time point at which the observation information is acquired;
calculating similarity information related to similarity in a set of observation information, corresponding to the time point information at a determination time point to determine whether the two or more users are accompanying, the set of observation information included in the received sensor information;
determining that the two or more users wearing the sensors having acquired the observation information used to calculate the similarity information are accompanying each other if the similarity information is similar enough to satisfy a predetermined condition; and
outputting information indicating a determination result as a result of the determining.

7. A computer readable storage medium storing a program causing a computer to execute a process for determining accompaniment, the process comprising:
receiving from sensors worn by two or more users sensor information that associates observation information acquired by the sensors with time point information indicating a time point at which the observation information is acquired;
calculating similarity information related to similarity in a set of observation information, corresponding to the time point information at a determination time point to determine whether the two or more users are accompanying, the set of observation information included in the received sensor information;
determining that the two or more users wearing the sensors having acquired the observation information used to calculate the similarity information are accompanying each other if the similarity information is similar enough to satisfy a predetermined condition; and
outputting information indicating a determination result as a result of the determining.
